(19) United States
(12) Patent Application Publication
(10) Pub. No.: US 2019/0004197 A1
(43) Pub. Date: Jan. 3, 2019

(54) UPDATING MODELS OF COMPLEX GEOLOGICAL SEQUENCES FIELD OF THE DISCLOSURE

(71) Applicant: LANDMARK GRAPHICS CORPORATION, Houston, TX (US)

(72) Inventors: William Clayton ROSS, Littleton, CO (US); Alice Jessica BUTT, Abingdon, Oxforshire (GB); Kieran BOWEN, Cowley, Oxford (GB)

(73) Assignee: LANDMARK GRAPHICS CORPORATION, Houston, TX (US)

(21) Appl. No.: 15/780,578

(22) PCT Filed: Mar. 9, 2016
(86) PCT No.: PCT/US2016/021575

§ 371 Date: May 31, 2018

(51) Int. Cl. G01V 1/30; G06T 17/05

(52) U.S. Cl. CPC G01V 1/302; G01V 2210/661; G06T 17/05

(57) ABSTRACT

Systems and methods for updating models of complex geological sequences using a sediment accumulation rate volume derived from a depth view and a time view of the complex geological sequences.

### FIELD OF THE DISCLOSURE

The present disclosure generally relates to systems and methods for updating models of complex geological sequences. More particularly, the present disclosure relates to updating models of complex geological sequences using a sediment accumulation rate volume derived from a depth view and a time view of the complex geological sequences.

### BACKGROUND

Modelling complex geological sequences may utilize conventional techniques such as, for example, proportional layering to create stratigraphic subdivisions between grids that represent a more detailed layering of the earth commonly referred to as a three dimensional (3D) systems tract interval depth model displayed as a depth view. This technique assumes a parallel and conformable geometric pattern for a gross interval thickness, which is the difference between two gridded surfaces. The gross interval thickness may be appropriate for certain portions of an overall depositional sequence (i.e., the top-set and bottom-set portions), but is inappropriate for the pro-grading, clinoform-dominated portions of the depositional sequence.

Another conventional technique for modelling complex geological sequences uses proportions and flattens all stratigraphic layers in geologic time in an attempt to restore the subsurface model into a 3D systems tract interval chronostratigraphic model displayed as a time view. In doing this, a mathematical technique is applied for proportional layering across the subsurface model. This technique has limited use when the goal is to model the entire depositional sequence (i.e., for areas with pro-gradational clinoforms that cannot be modeled using conventional approaches to proportional layering).

Related techniques for modelling complex geological sequences may use automated seismic horizon tracking and model-building to create 3D subsurface models that can be translated into a time view. The 3D subsurface model is created by direct interpretation of seismic data. In other words, the 3D subsurface model is derived directly from densely sampled seismic data. This technique extracts time-stratigraphic surfaces from seismic data (using coherence attributes) to build a time-stratigraphic 3D subsurface model. Then, the time-stratigraphic 3D subsurface model is translated into a time view. This approach can work when available seismic data has a high signal-to-noise ratio. In regions of poor quality seismic data, however, this technique is undesirable.

Although conventional techniques exist for creating a time view of the 3D systems tract interval model from a depth view of the 3D systems tract interval model, and vice versa, such techniques do not address automatically updating one view based on edits to an erosional unconformity in the other view. Moreover, such techniques do not address automatically restoring eroded surfaces in a depth view based on erosional unconformities in the time view and automatically updating a depth view based on subdivided system tract intervals in the time view.

### BRIEF DESCRIPTION OF THE DRAWINGS

The present disclosure is described below with references to the accompanying drawings in which like elements are referenced with like reference numerals, and in which:

FIG. 1 is a flow diagram illustrating one embodiment of a method for implementing the present disclosure.

FIGS. 2A-2B are system tract interval diagrams illustrating step 102 in FIG. 1.

FIGS. 3A-3B are system tract interval diagrams illustrating step 104 in FIG. 1.

FIGS. 4A-4B are system tract interval diagrams illustrating step 106 in FIG. 1.

FIGS. 5A-5B are system tract interval diagrams illustrating steps 110 and 112, respectively, in FIG. 1.

FIG. 6A is a system tract interval diagram illustrating step 116 in FIG. 1.

FIGS. 6B-6C are system tract interval diagrams illustrating step 118 in FIG. 1

FIGS. 7A-7B are system tract interval diagrams illustrating steps 122 and 124, respectively, in FIG. 1

FIG. 8 is a block diagram illustrating one embodiment of a computer system for implementing the present disclosure.

### DETAILED DESCRIPTION OF THE PREFERRED EMBODIMENTS

The present disclosure overcomes one or more deficiencies in the prior art by providing systems and methods for updating models of complex geological sequences using a sediment accumulation rate volume derived from a depth view and a time view of the complex geological sequences.

In one embodiment, the present disclosure includes a method for updating models of complex geological sequences, which comprises: i) calculating a sediment accumulation rate volume by dividing a thickness between each system tract interval in a depth view of a three-dimensional systems tract interval model by a difference in time between each system tract interval in a time view of the three-dimensional systems tract interval model, wherein a thickness for each system tract interval vertically bound under each respective erosional unconformity is excluded from the calculation; ii) editing at least one erosional unconformity in an actual top-surface in one of the depth view and the time view; and iii) updating one of the depth view and the time view using the sediment accumulation rate volume, the edited one of the depth view and the time view and a computer processor.

In another embodiment, the present disclosure includes a non-transitory program carrier device tangibly carrying computer executable instructions for updating models of complex geological sequences, the instructions being executable to implement: i) calculating a sediment accumulation rate volume by dividing a thickness between each system tract interval in a depth view of a three-dimensional systems tract interval model by a difference in time between each system tract interval in a time view of the three-dimensional systems tract interval model, wherein a thickness for each system tract interval vertically bound under each respective erosional unconformity is excluded from the calculation; ii) editing at least one erosional unconformity in an actual top-surface in one of the depth view and the time view; and iii) updating one of the depth view and the time view using the sediment accumulation rate volume and the edited one of the depth view and the time view.

In yet another embodiment, the present disclosure includes a non-transitory program carrier device tangibly carrying computer executable instructions for updating models of complex geological sequences, the instructions being executable to implement: i) calculating a sediment accumulation rate volume; ii) editing at least one erosional unconformity in an actual top-surface in one of the depth view and the time view; iii) updating one of the depth view and the time view using the sediment accumulation rate volume and the edited one of the depth view and the time view; iv) editing one of the edited time view and the updated time view to display an age range between each erosional unconformity and each respective actual top-surface for each system tract interval removed by erosion; and v) restoring each system tract interval removed by erosion in one of the edited depth view and the updated depth view by multiplying a) a difference in time between each erosional unconformity and each respective actual top-surface for each system tract interval removed by erosion in a last edited time view; and b) a sediment accumulation rate from the sediment accumulation rate volume under each erosional unconformity in the last edited time view.

The subject matter of the present disclosure is described with specificity, however, the description itself is not intended to limit the scope of the disclosure. The subject matter thus, might also be embodied in other ways, to include different structures, steps and/or combinations similar to those described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the present disclosure may be described with respect to the oil and gas industry, it is not limited thereto and may also be applied in other industries (e.g. drilling water wells) to achieve similar results.

### METHOD DESCRIPTION

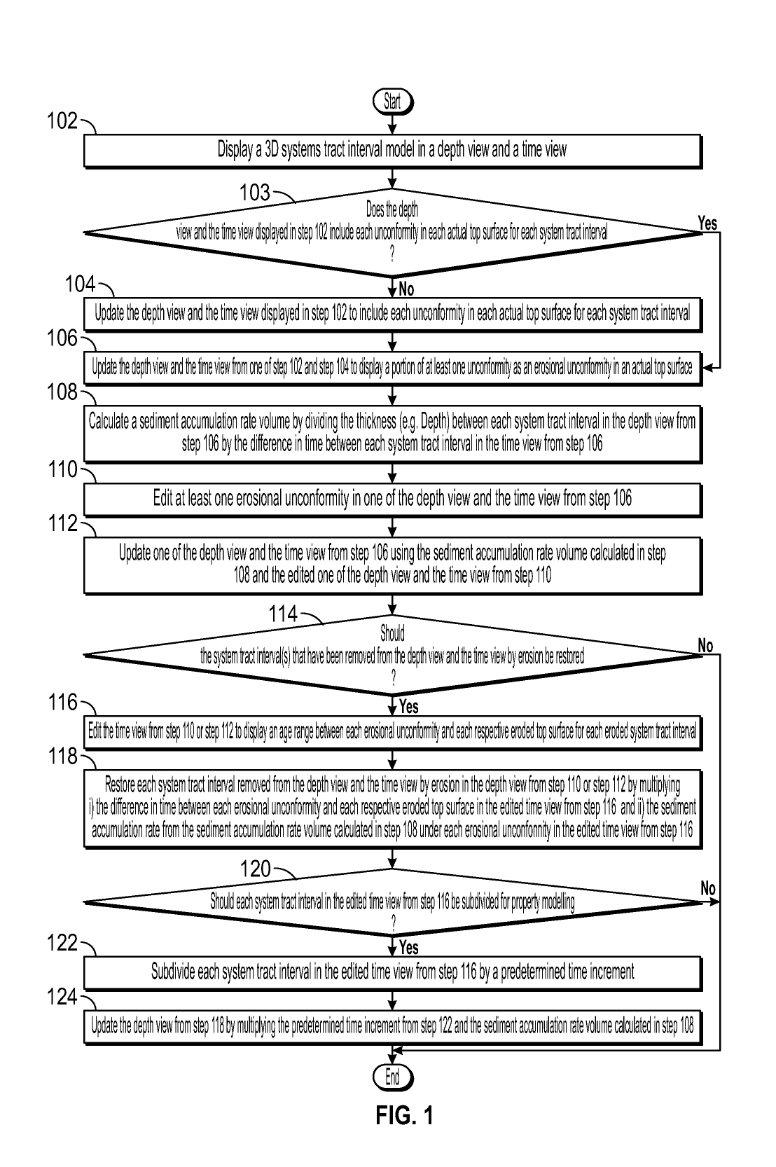

Referring now to FIG. 1, a flow diagram illustrates one embodiment of a method 100 for implementing the present disclosure.

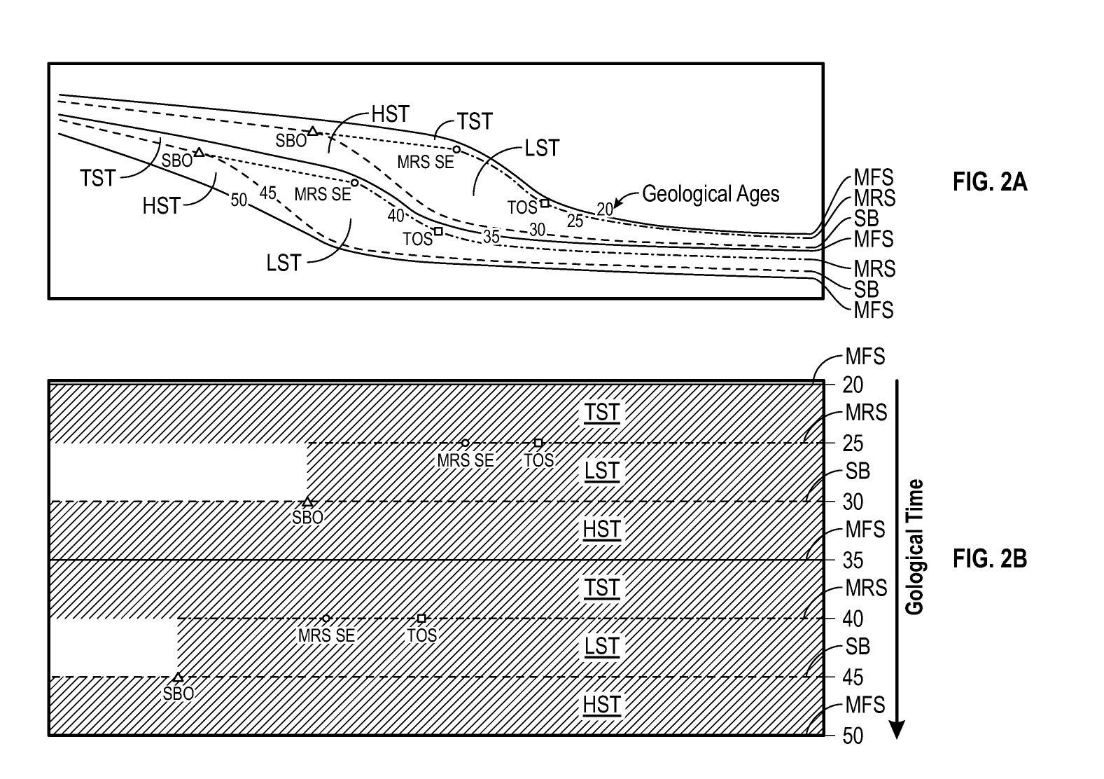

In step 102, a 3D systems tract interval model is displayed in a depth view and a time view. The 3D systems tract interval model properly accounts for basin fill histories where deposition, non-deposition and erosion vary in complex patterns across time and space. In FIGS. 2A-2B, the system tract interval diagrams illustrate an exemplary 3D systems tract interval model in a depth view and a time view, respectively. In each view, the system tract intervals (TST, HST, LST) and their respective actual top surfaces (MFS, SB, MRS) are illustrated with the MRS shelf edge positions (MRS SE), the sequence boundary offlap positions (SBO) and the toe of slope positions (TOS). Each system tract interval lies between the actual top surface (MFS, MRS, SB) and an actual bottom surface. TST is the transgressive systems tract, HST is the highstand systems tract, and LST is the lowstand systems tract. MFS is the maximum flooding surface, which is the top of the TST. The SB is the sequence boundary, which is the top of the HST. And, MRS is the maximum regressive surface, which is the top of the LST. The depth view (FIG. 2A) and the time view (FIG. 2B) are preferably displayed in a vertical relationship to illustrate a correlation between the actual top surfaces, the MRS shelf edge positions (MRS SE), the sequence boundary offlap positions (SBO) and the toe of slope positions (TOS). Both the depth view and the time view are thus, comprised of the same system tract intervals. In the depth view, the system tract intervals are stacked vertically. The spacing of these lines is the geologic depth interval. In the time view, the system tract intervals are arranged in parallel lines. The spacing of these lines is the geologic time interval. The time view has the advantage of being able to represent rocks that were deposited and then subsequently eroded.

In step 103, the method 100 determines if the depth view and the time view displayed in step 102 include each unconformity in each actual top surface for each system tract interval. An unconformity is either a disconformity or a top-lap type of actual top surface. If the depth view and the time view displayed in step 102 include each unconformity in each actual top surface for each system tract interval, then the method 100 proceeds to step 106. Otherwise, the method 100 proceeds to step 104.

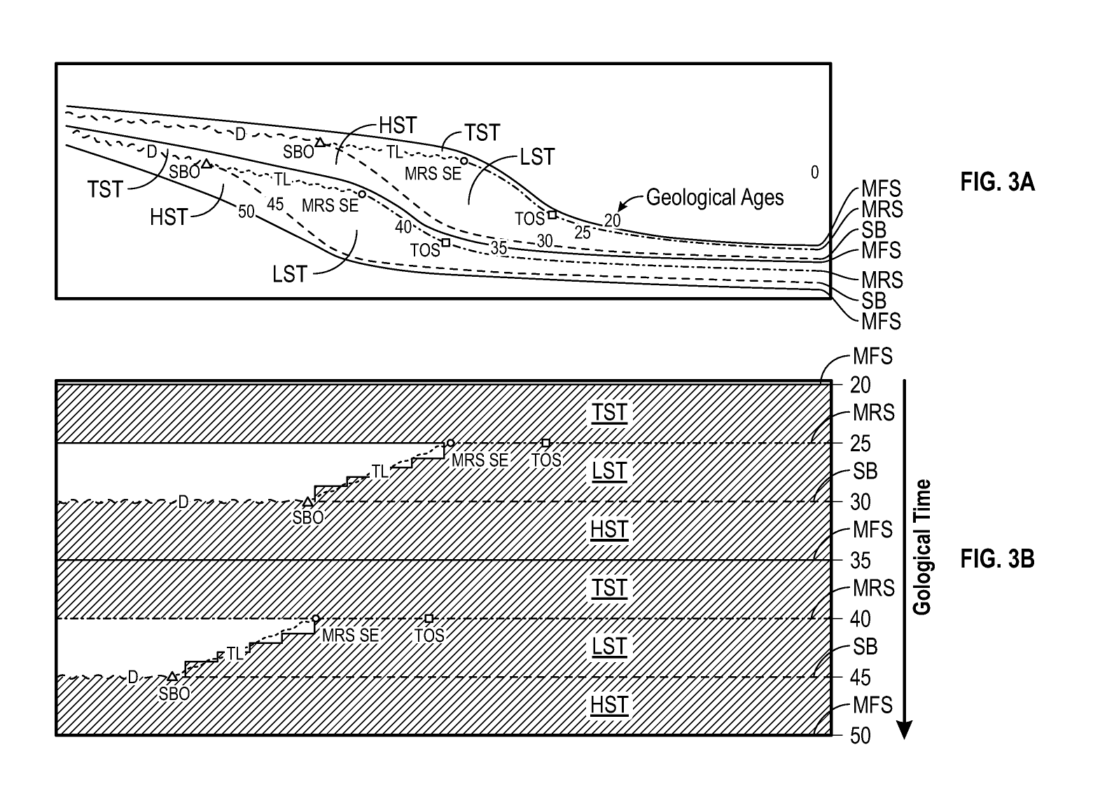

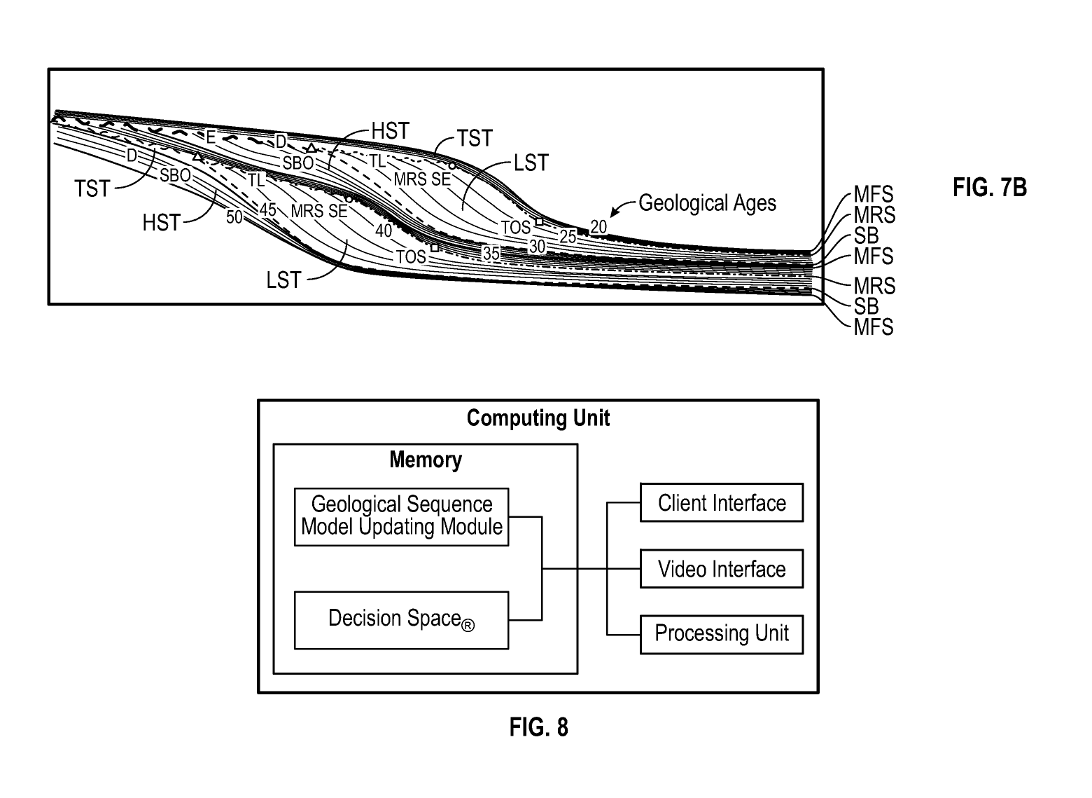

In step 104, the depth view and the time view displayed in step 102 are automatically updated to include each unconformity in each actual top surface for each system tract interval. Alternatively, the depth view and the time view displayed in step 102 may be updated to include each unconformity in each actual top surface for each system tract interval using the client interface and/or the video interface described further in reference to FIG. 8. In either manner, each view is automatically updated to reflect edits automatically or manually made to the other view using techniques well known in the art. In this manner, isochronous actual top surfaces are transformed into diachronous actual top surfaces. This alters the sediment accumulation rate, also known as a depositional rate, under each unconformity. In FIGS. 3A-3B, the system tract interval diagrams illustrate the depth view and the time view in FIGS. 2A-2B, respectively, updated to include an unconformity (i.e. disconformity (D)) in the SB actual top surface and another unconformity (i.e. top-lap(TL)) in the MRS actual top surface.

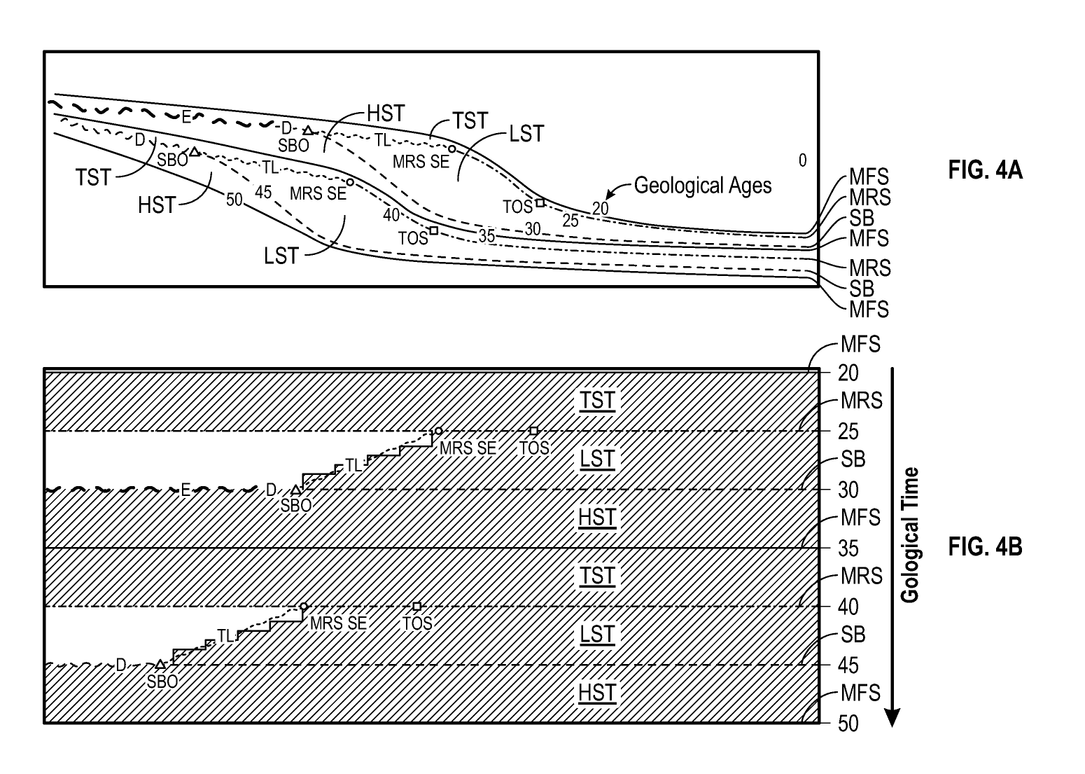

In step 106, the depth view and the time view from one of step 102 and step 104 are automatically updated to display a portion of at least one unconformity as an erosional unconformity in an actual top surface. Alternatively, the depth view and the time view from one of step 102 and step 104 may be updated to display a portion of at least one unconformity as an erosional unconformity in an actual top surface using the client interface and/or the video interface described further in reference to FIG. 8. In either manner, each view is automatically updated to reflect edits automatically or manually made to the other view using techniques well known in the art. In FIGS. 4A-4B, the system tract interval diagrams illustrate the depth view and the time view in FIGS. 3A-3B, respectively, updated to display a portion of the unconformity (i.e. disconformity (D)) in the SB actual top surface as an erosional unconformity (E). Alternatively, a portion of the top-lap (TL) unconformity in either MRS actual top surface could be updated to display as an erosional unconformity.

In step 108, a sediment accumulation rate volume is automatically calculated by dividing the thickness (e.g. depth) between each system tract interval in the depth view from step 106 by the difference in time between each system tract interval in the time view from step 106. The thickness for each system tract interval vertically bound under each respective erosional unconformity is excluded from the calculation.

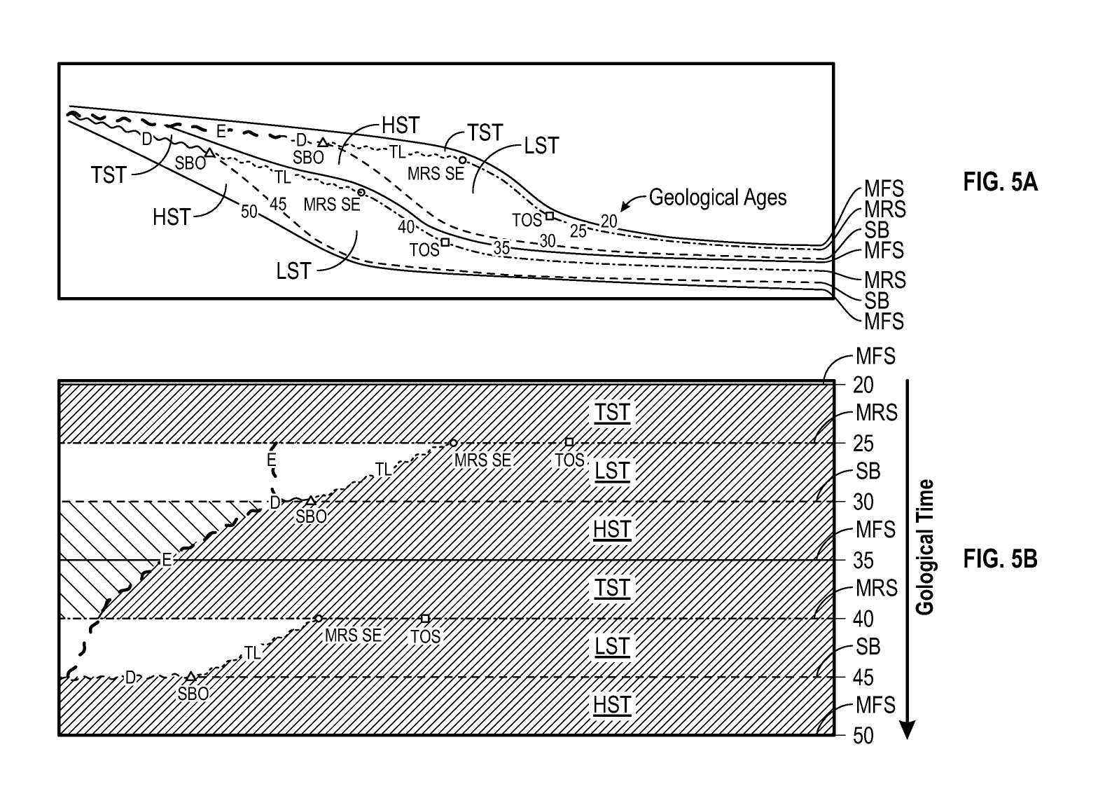

In step 110, at least one erosional unconformity in one of the depth view and the time view from step 106 is edited using the client interface and/or the video interface described further in reference to FIG. 8. The edit may include moving and/or extending the erosional unconformity either up or down. In FIG. 5A, the system tract interval diagram illustrates the depth view in FIG. 4A with the erosional unconformity (E) edited (i.e. moved down and extended).

In step 112, one of the depth view and the time view from step 106 are automatically updated using the sediment accumulation rate volume calculated in step 108 and the edited one of the depth view and the time view from step 110. If at least one erosional unconformity in the depth view is edited in step 110, then the time view is automatically updated by: Time View (updated)=Depth View (edited)/Sediment Accumulation Rate Volume. The thickness for each system tract interval vertically bound under each respective erosional unconformity is excluded from the sediment accumulation rate calculation. If at least one erosional unconformity in the time view is edited in step 110, then the depth view is automatically updated by: Depth View (updated)=Time View (edited)*Sediment Accumulation Rate Volume. In FIG. 5B, the system tract interval diagram illustrates the time view in FIG. 4B with the erosional unconformity (E) edited (i.e. moved down and extended).

In step 114, the method 100 determines whether the system tract interval(s) that have been removed from the depth view and the time view by erosion should be restored for determining basin evolution. If there are any system tract intervals that have been removed from the depth view and the time view by erosion that should not be restored, then the method 100 ends. Otherwise, the method 100 proceeds to step 116.

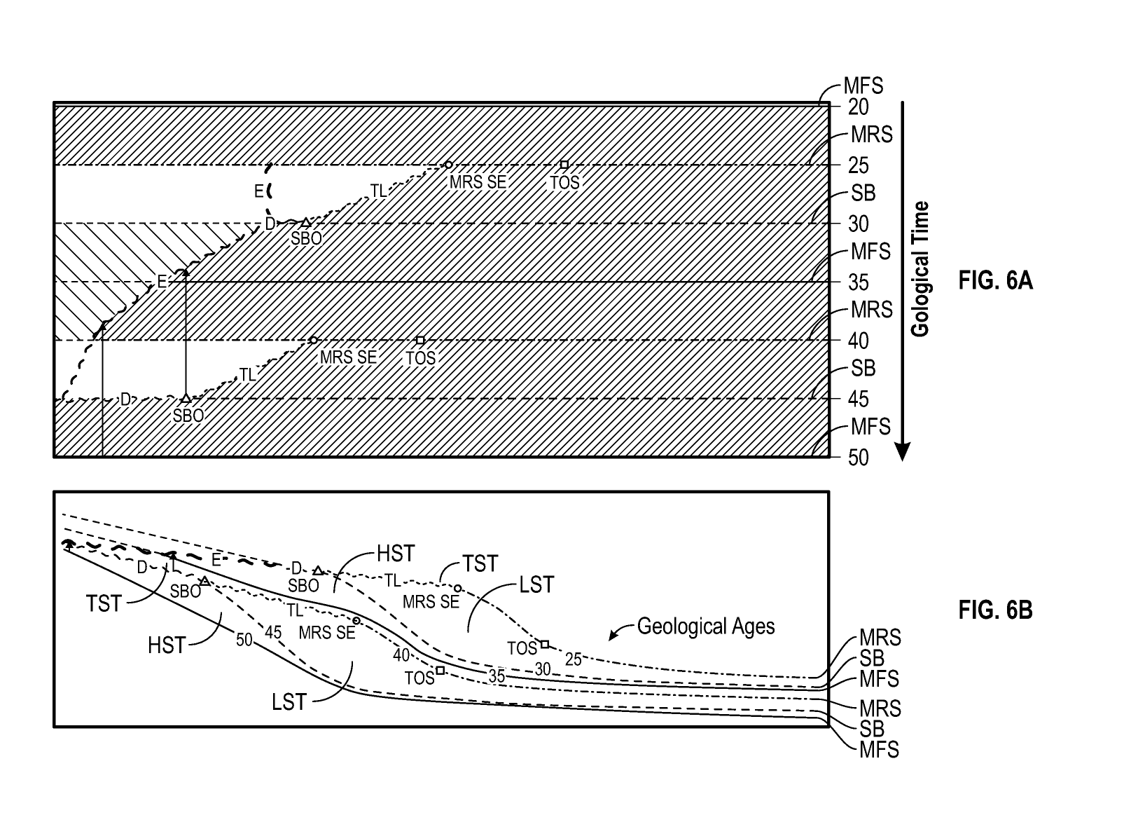

In step 116, the time view from step 110 or step 112 is edited to display an age range between each erosional unconformity and each respective eroded top surface for each eroded system tract interval using the client interface and/or the video interface described further in reference to FIG. 8 and techniques well known in the art. In FIG. 6A, the system tract interval diagram illustrates the time view in FIG. 5B edited to display an age range of the erosional unconformity (E) by the diagonal lines and each eroded top surface for each eroded system tract interval by the dashed lines. The vertical arrows in FIGS. 6A and 6B represent the extent of system tract intervals to be restored. In addition, this step may be used to define the minimum age for the system tract intervals to be restored (e.g. 25 in FIG. 6A).

In step 118, each system tract interval removed from the depth view and the time view by erosion is automatically restored in the depth view from step 110 or step 112 by multiplying i) the difference in time between each erosional unconformity and each respective eroded top surface in the edited time view (arrows in FIG. 6A) from step 116; and ii) the sediment accumulation rate from the sediment accumulation rate volume calculated in step 108 under each erosional unconformity in the edited time view from step 116. In FIGS. 6B-6C, the system tract interval diagrams illustrate the depth view in FIG. 5A before each system tract interval removed by erosion is restored (FIG. 6B dashed lines showing extension of MFS and SB actual top surfaces and adjusted erosional unconformity (E)) and after each system tract interval removed by erosion is restored (FIG. 6C showing extension of MFS and SB actual top surfaces and adjusted erosional unconformity (E)).

In step 120, the method 100 determines if each system tract interval in the edited time view from step 116 should be subdivided for property modelling. If each system tract interval in the edited time view should not be subdivided, then the method 100 ends. Otherwise, the method 100 proceeds to step 122.

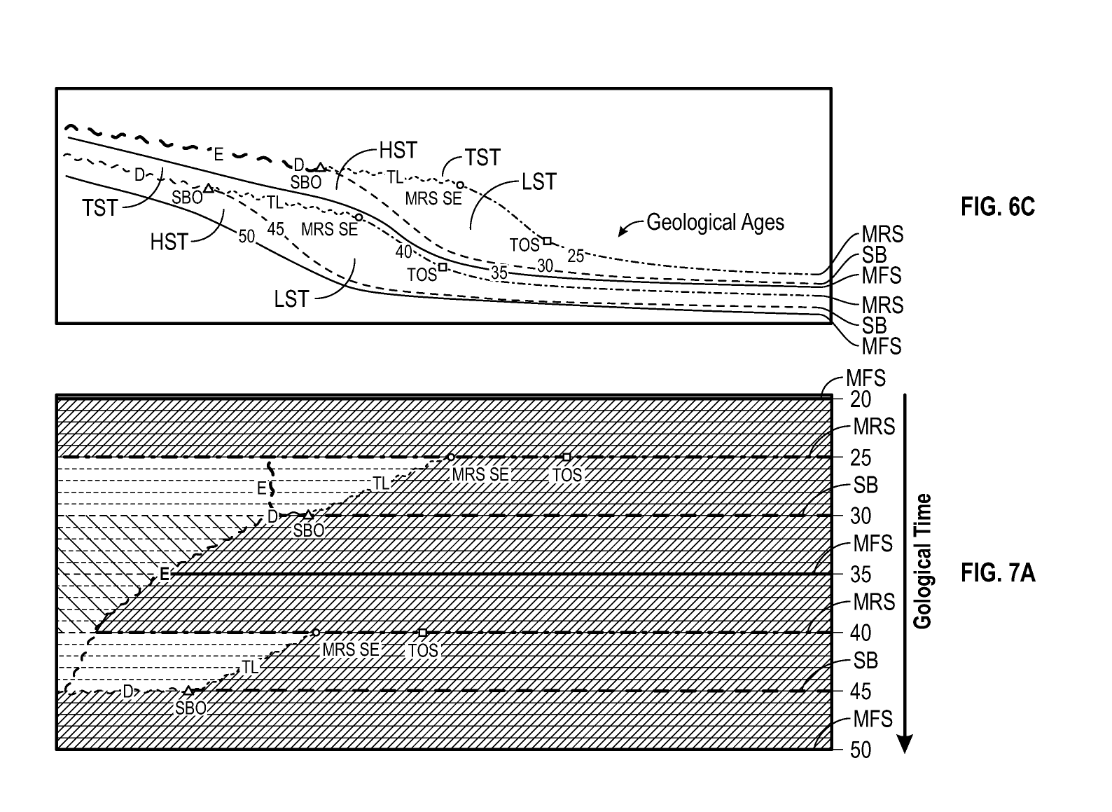

In step 122, each system tract interval in the edited time view from step 116 is subdivided by a predetermined time increment. In FIG. 7A, the system tract interval diagram illustrates the time view in FIG. 6A subdivided by a predetermined time increment.

In step 124, the depth view from step 118 is automatically updated by multiplying the predetermined time increment from step 122 and the sediment accumulation rate volume calculated in step 108. In FIG. 7B, the system tract interval diagram illustrates the depth view in FIG. 6C updated by the edited time view in FIG. 7A.

The method 100 thus, manages preservation limits and proportional thicknesses. As edits to preservation limits and proportional thicknesses are made, the 3D systems tract interval model is updated in the depth view or the time view. The method 100 thus, facilitates the interplay between interpretations performed in the time view and the depth view. Given the importance of the chronostratigraphic aspects of preserved (and unpreserved) sediments in the process of stratigraphic prediction, the method 100 is the only practical means for geoscientists to view and edit the complete set of instructions for constructing complex geologic sequence models. The method 100 thus, improves stratigraphic prediction in order to more accurately determine well positioning.

### SYSTEM DESCRIPTION

The present disclosure may be implemented through a computer-executable program of instructions, such as program modules, generally referred to as software applications or application programs executed by a computer. The software may include, for example, routines, programs, objects, components and data structures that perform particular tasks or implement particular abstract data types. The software forms an interface to allow a computer to react according to a source of input. DecisionSpace®, which is a commercial software application marketed by Landmark Graphics Corporation, may be used as an interface application to implement the present disclosure. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g. various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof, in a computer system or other processing system.

Referring now to FIG. 8, a block diagram illustrates one embodiment of a system for implementing the present disclosure on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the disclosure.

The memory primarily stores the application programs, which may also be described as program modules containing computer-executable instructions, executed by the computing unit for implementing the present disclosure described herein and illustrated in FIGS. 1-7. The memory therefore, includes a geological sequence model updating module, which enables steps 103-124 described in reference to FIG. 1. The geological sequence model updating module may integrate functionality from the remaining application programs illustrated in FIG. 8. In particular, DecisionSpace® may be used as an interface application to perform step 102 in FIG. 1. Although DecisionSpace® may be used as interface application, other interface applications may be used, instead, or the geological sequence model updating module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well-known.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof.

What is claimed:

1. A method for updating models of complex geological sequences, which comprises:
calculating a sediment accumulation rate volume by dividing a thickness between each system tract interval in a depth view of a three-dimensional systems tract interval model by a difference in time between each system tract interval in a time view of the three-dimensional systems tract interval model, wherein a thickness for each system tract interval vertically bound under each respective erosional unconformity is excluded from the calculation;
editing at least one erosional unconformity in an actual top-surface in one of the depth view and the time view; and
updating one of the depth view and the time view using the sediment accumulation rate volume, the edited one of the depth view and the time view and a computer processor.

2. The method of claim 1, wherein the time view is updated by dividing the edited depth view by the sediment accumulation rate volume.

3. The method of claim 1, wherein the depth view is updated by multiplying the edited time view and the sediment accumulation rate volume.

4. The method of claim 1, further comprising:
editing one of the edited time view and the updated time view to display an age range between each erosional unconformity and each respective actual top-surface for each system tract interval removed by erosion; and
restoring each system tract interval removed by erosion in one of the edited depth view and the updated depth view by multiplying i) a difference in time between each erosional unconformity and each respective actual top-surface for each system tract interval removed by erosion in a last edited time view; and ii) a sediment accumulation rate from the sediment accumulation rate volume under each erosional unconformity in the last edited time view.

5. The method of claim 4, further comprising:
subdividing each system tract interval in the last edited time view by a predetermined increment; and
updating the restored depth view by multiplying the predetermined time increment and the sediment accumulation rate volume.

6. The method of claim 1, wherein the erosional unconformity is a portion of a disconformity in the actual top-surface.

7. The method of claim 1, wherein the erosional unconformity is a top-lap in the actual top-surface.

8. The method of claim 1, further comprising positioning a well based on the updated one of the depth view and the time view.

9. The method of claim 4, further comprising defining a minimum age for each system tract interval removed by erosion.

10. A non-transitory program carrier device tangibly carrying computer executable instructions for updating models of complex geological sequences, the instructions being executable to implement:
calculating a sediment accumulation rate volume by dividing a thickness between each system tract interval in a depth view of a three-dimensional systems tract interval model by a difference in time between each system tract interval in a time view of the three-dimensional systems tract interval model, wherein a thickness for each system tract interval vertically bound under each respective erosional unconformity is excluded from the calculation;
editing at least one erosional unconformity in an actual top-surface in one of the depth view and the time view; and
updating one of the depth view and the time view using the sediment accumulation rate volume and the edited one of the depth view and the time view.

11. The program carrier device of claim 10, wherein the time view is updated by dividing the edited depth view by the sediment accumulation rate volume.

12. The program carrier device of claim 10, wherein the depth view is updated by multiplying the edited time view and the sediment accumulation rate volume.

13. The program carrier device of claim 10, further comprising:
editing one of the edited time view and the updated time view to display an age range between each erosional unconformity and each respective actual top-surface for each system tract interval removed by erosion; and
restoring each system tract interval removed by erosion in one of the edited depth view and the updated depth view by multiplying i) a difference in time between each erosional unconformity and each respective actual top-surface for each system tract interval removed by erosion in a last edited time view; and ii) a sediment accumulation rate from the sediment accumulation rate volume under each erosional unconformity in the last edited time view.

14. The program carrier device of claim 13, further comprising:
subdividing each system tract interval in the last edited time view by a predetermined increment; and
updating the restored depth view by multiplying the predetermined time increment and the sediment accumulation rate volume.

15. The program carrier device of claim 10, wherein the erosional unconformity is a portion of a disconformity in the actual top-surface.

16. The program carrier device of claim 10, wherein the erosional unconformity is a top-lap in the actual top-surface.

17. The program carrier device of claim 10, further comprising positioning a well based on the updated one of the depth view and the time view.

18. The program carrier device of claim 13, further comprising defining a minimum age for each system tract interval removed by erosion.

19. A non-transitory program carrier device tangibly carrying computer executable instructions for updating models of complex geological sequences, the instructions being executable to implement:
calculating a sediment accumulation rate volume;
editing at least one erosional unconformity in an actual top-surface in one of the depth view and the time view;
updating one of the depth view and the time view using the sediment accumulation rate volume and the edited one of the depth view and the time view;
editing one of the edited time view and the updated time view to display an age range between each erosional unconformity and each respective actual top-surface for each system tract interval removed by erosion; and
restoring each system tract interval removed by erosion in one of the edited depth view and the updated depth view by multiplying i) a difference in time between each erosional unconformity and each respective actual top-surface for each system tract interval removed by erosion in a last edited time view; and ii) a sediment accumulation rate from the sediment accumulation rate volume under each erosional unconformity in the last edited time view.

20. The program carrier device of claim 19, further comprising:
subdividing each system tract interval in the last edited time view by a predetermined increment; and
updating the restored depth view by multiplying the predetermined time increment and the sediment accumulation rate volume.
